(19) United States
(12) Patent Application Publication
(10) Pub. No.: US 2011/0307479 A1
(43) Pub. Date: Dec. 15, 2011

(54) Automatic Extraction of Structured Web Content

(75) Inventors: Xiaoxin Yin, Bothell, WA (US); Wenzhao Tan, Redmond, WA (US); Xiao Li, Bellevue, WA (US); Yi-Chin Tu, Sammamish, WA (US); Yutaka Suzue, Issaquah, WA (US); Johnson T. Apacible, Mercer Island, WA (US)

(73) Assignee: MICROSOFT CORPORATION, Redmond, WA (US)

(21) Appl. No.: 12/797,614

(22) Filed: Jun. 10, 2010

(51) Int. Cl. G06F 17/30

(52) U.S. Cl. 707/728; 707/780; 707/E17.108

(57) ABSTRACT

Described is extracting structured information from web pages for use in directly answering queries with data items from the structured data. Users' post-search browsing behaviors (search trails) are treated as implicit labels as to the relevance between web content and user queries, and are used to determine wrappers for extracting structured information. In one implementation, a system identifies websites from web search logs, builds wrappers from users' search trails, filters out bad wrappers (from inconsistent user clicks), and combines structured information from different web sites, e.g., for each query.

### BACKGROUND

Although web search engines have evolved considerably, queries are still primarily responded to with a results page containing ten results in the form of URL links with accompanying snippets. After submitting a search query, a user generally needs to read each snippet to decide whether the corresponding web page likely has content relevant to the search.

Reviewing snippets to hopefully find a page that is relevant is often inconvenient to users, even though in many instances it may be readily apparent (that is, to a human) what information the user is very likely intending to receive. For example, if a user submits a query identifying some famous musician and the term “songs,” e.g., “<musician name> songs” or the like, the user is very likely looking for a page that lists the songs of that musician, possibly for listening to a song or purchasing one to download.

If the search engine showed a list of songs as results for this query, or converted the snippets for at least some of the search results into a list of songs, the user may readily see relevant information and interact as desired, such as to quickly select a link and start listening to a song. At present, however, most search engines do not have the ability to more directly respond to such a query in a general and automatically triggered way, and continue to provide conventional search results.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which structured information is extracted from sets of URLs, such as sets of uniformly formatted URLs. Search trails, comprising users' post-search click behaviors, are accessed to determine wrappers for extracting data items from web pages that correspond to each set. From these wrappers, relevant data items are determined from the data items extracted from the web pages, including by filtering out irrelevant wrappers.

In one aspect, a pattern summarizer performs a process to summarize patterns of URLs to provide sets of uniformly formatted URLs. This is performed for name entities of different categories, by processing one or more query logs that indicate user clicks on URLs returned in a search page, to find common patterns.

In one aspect, the search trail data is processed to generate a set of candidate wrappers, which will be used to determine an entity name for each page. A wrapper is selected from among the candidate wrappers, including by applying each candidate wrapper to the pages to obtain one or more strings extracted by that candidate wrapper, and selecting the wrapper based on the entity name versus each string extracted by that candidate wrapper, e.g., when a wrapper extracts one string that exactly matches the entity name.

In one implementation, the relevant data items are determined from among the extracted data items via an approach based on graph-regularization. Each item is represented as a node in the graph, with an edge between each pair of data items that are extracted using the same wrapper. Each node is assigned a score indicating a likelihood of relevance for that node's associated data item. The graph is then processed to determine whether a wrapper provides relevant or irrelevant items.

Once extracted, the structured data/data items may be accessed to provide a more directed search result in response to a query. Further, search results may be ranked based upon the predicted relevance of data items determined from one or more search and browsing logs.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block/data flow diagram representing components in a system for extracting structured data from web pages for more directly answering queries.

FIG. 2 is flow diagram representing example steps that may be taken to process URLs into patterns to provide sets of uniformly formatted URLs.

FIG. 3 is flow diagram representing example steps that may be taken to process pages of elements to determine candidate wrappers for extracting structured data.

FIG. 4 is a block representing components for more directly answering queries using structured data extracted from web pages.

FIG. 5 shows an illustrative example of a computing environment into which various aspects of the present invention may be incorporated.

### DETAILED DESCRIPTION

Various aspects of the technology described herein are generally directed towards extracting structured information from web pages, which can be used to more directly answer queries, e.g., by directly showing the content being searched for by a user. To this end, users' post-search browsing behaviors, referred to as “search trails” of web search queries, are processed to determine information about semantics of web contents and their relationships to web queries. The search trails are used to generate wrappers that extract structured information from the web; this extracted information then may be used to more directly answer user queries. Further, users' search and browsing logs may be used to predict relevance of data items and rank them in the search results.

In one implementation, the search trails comprise a sequence of URLs that a user has clicked after submitting a query and clicking a search result. Because these post-search clicks are usually for fulfilling the original query intent, the content being clicked (e.g., the clicked URLs and their anchor texts) are considered as implicit labels from users. As described below, such labels are used to build wrappers for extracting more data to answer queries; (note that there are a number of known solutions for automatically building wrappers).

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and search technology in general.

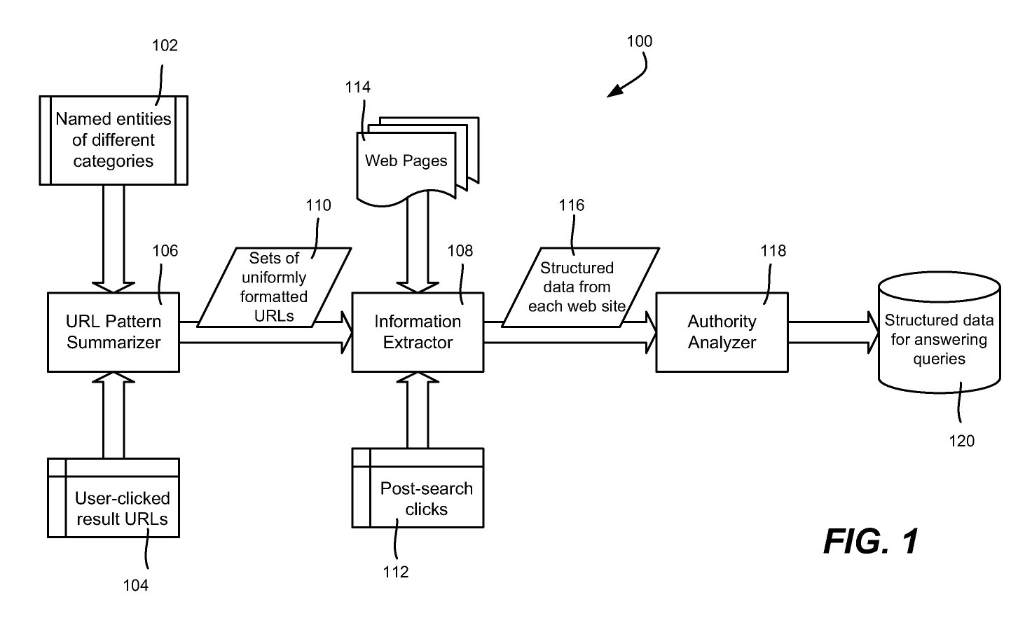

FIG. 1 is a block diagram showing an extraction system 100 that generates structured data, such as for different generic and popular search intents for a category of entities (e.g., songs of musicians, attractions of cities and so forth). In one implementation, the extraction system 100 is a fully automated system that does not require any manual labeling or supervision.

As described below, based on user search trails of queries, the extraction system 100 extracts structured data from web pages, and assigns semantics to extracted data based on user queries. For example, the system uses web search queries containing name entities of each category (e.g., musicians), and possibly a word or phrase indicating generic and popular intent for that category of entities (e.g., songs of musicians). A word (or phrase) that co-appears with many entities of a category in user queries may be referred to as an “intent word” for that category. The system may build a wrapper from a small number of user clicks, and apply the wrapper to web pages of the same format to extract information.

Then, given a user query containing a name entity and a search intent for which data has been extracted, relevant extracted data items may be found based on the assigned semantics, and users' search and browsing logs accessed to rank the extracted data items.

In general, the system inputs name entities 102 of different categories (e.g., musicians, actors, cities, national parks), and user-clicked result URLs 104. The name entities 102 may be found from the titles or headers of articles within each category, reference-type sites, databases, shopping or other websites, and/or by using automatic approaches to collect them.

The URL pattern summarizer 106 takes the different categories of name entities 102 as input, and finds queries comprising an entity in some category, along with an intent word. The URL pattern summarizer 106 analyzes the clicked result URLs for these queries to find sets of URLs sharing the same pattern, which correspond to web pages of uniform (or highly similar) format. For example, a website may have a page for each musician with URLs like http://www.music.site/music/*/, and such pages are often clicked for queries like {[musician] songs}. Additional details of the URL pattern summarizer 106 are set forth below.

The information extractor 108 takes the output of the URL pattern summarizer (each set of uniformly formatted web pages 110) and analyzes the post-search clicks 112 on them. More particularly, after a user submits a query, the user often clicks on a result URL, and once on that URL's page, that user may make one or more clicks, referred to as “follow-up clicks.” Such clicked links are often relevant to the user's original search intent, and thus each link from follow-up clicks may be treated as a relevant item for the original query. The post-search clicks 112 thus comprise the search trails of users, i.e., the clicks made by users after querying a search engine (e.g., Bing), which can be found in the browsing logs of consenting users of browsers.

Using (e.g., known automatic) wrapper-building technology, the information extractor 108 builds one or more wrappers for the entity names, clicked URLs and their anchor texts, and extracts such information from web pages 114 of the same format, which may be independent of whether they have been clicked or not. The web pages generally comprise a reasonably comprehensive set of HTML pages on the web, such as retrieved from the index of Bing.com. Additional details of the information extractor 108 are set forth below.

The output of the information extractor 108, namely structured data 116 from each website, is input by an authority analyzer 118 for further processing, essentially to eliminate noise. More particularly, these extracted data 116 may contain a significant amount of noise in the implicit labels inferred from user clicks and also in extracted data, because users sometimes click on links that are irrelevant to their original search intents. For example, a user may request a musician's songs, but decide to click on a link related to an upcoming event related to that musician, causing noise in the system.

The authority analyzer 118 takes the data 116 extracted from the different websites, and infers the relevance of data and the authority of websites, such as by using a graph-regularization approach (described below). Note that items extracted by the same wrapper are from certain uniformly (or at least highly similar) formatted parts in web pages and thus are usually of the same type, which means they tend to be usually all relevant or all irrelevant. The authority analyzer 118 merges the relevant data into structured data 120 for answering queries, for accessing and showing to a user when receiving a suitable query. Additional details of the information extractor 108 are set forth below.

Turning to additional details of the URL pattern summarizer 106, in one implementation the data consumed by the information extractor 108 needs to be applied to web pages with a uniform format from the result pages clicked by users for each category of entities and each intent word. In general, because of the large number of pages involved, it is prohibitively expensive to compare the formats of these pages; however pages of uniform format usually share a common URL pattern. For example, each page for a musician on a website has a URL such http://www.music.site/music/*/, and each page of songs of a musician on another site has a URL like http://other.music.site.com/*/tracks. The URL pattern summarizer 106 finds such URL patterns from the search result URLs clicked by users, which frequently correspond to sets of uniformly formatted pages.

To this end, the URL pattern summarizer 106 takes a relatively large number of URLs from each domain, and finds popular patterns of URLs, where a URL pattern contains a list of tokens, each being a string or a “*” (wildcard). In one implementation, a URL pattern matches with a URL if the strings in the pattern can be matched in the URL and each wildcard matches with a string without token separators (“/”, “.”, “&”, “?”, “=”).

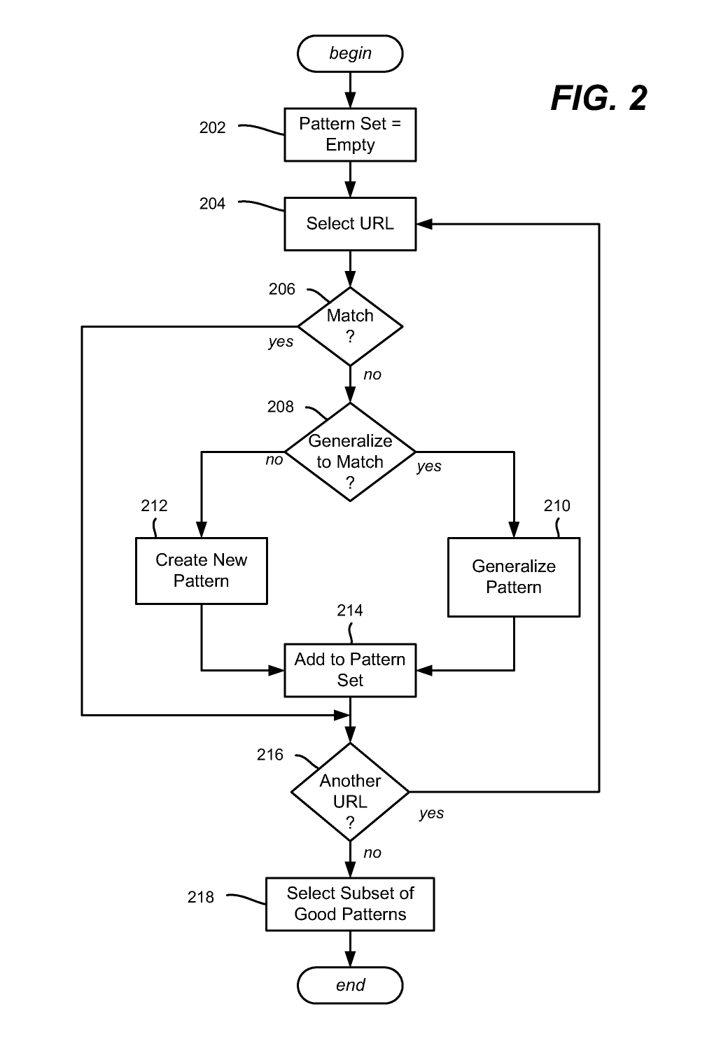

As generally represented in the steps of FIG. 2, given a set of URLs, at step 202 the process starts from an empty pattern set, and iterates (steps 204 and 216) through the URLs, trying to match (step 206) each URL with every existing pattern. If a pattern needs to be generalized (e.g., include new wildcard) to match with a URL, the generalized pattern may be included into the pattern set as well, as represented by steps 208, 210 and 214. Via step 212 a new pattern also may be created based on each URL, that is, one that cannot be matched with an existing pattern or generalized from one, and added at step 214.

When matching a URL with a pattern there are three outcomes, namely matched, not matched because they have different number of tokens or different token separators, and compromised, i.e., the pattern needs to be generalized to match with the URL. By way of example, consider a pattern p1=http://www.xyzdb.com/name/nm0000*. For URL u1=http://www.xyzdb.com/name/nm2067953/, p1 and u1 are compromised to form pattern http://www.xyzdb.com/name/nm*. For URL u2=http://www.xyzdb.com/title/tt0051418/, p1 and u1 are compromised to generate pattern http://www.imdb.com/*/*. For URL http://www.xyzdb.com/video/xyzdb/vi3338469913/, p1 cannot be matched with it.

Given the clicked result URLs, a goal is to select a list of URL patterns, so that most URLs can match with at least one pattern. A general goal is to have each pattern match many URLs, yet be as different as possible so that the pattern does not match URLs of different formats. Note that the process divides the result URLs by their web domains so as to not process patterns applicable to multiple domains.

To this end, while iterating to match each URL with every existing pattern, if a URL and a pattern are compromised with a new pattern generated, the new pattern is included into the pattern set; a new pattern based on each URL is created when they cannot be matched or compromised with an existing pattern and there are already many patterns (e.g., greater than one-hundred).

Once a set of patterns is generated after iterating through the URLs in a domain, a subset of good patterns needs to be selected (step 218), where “good” refers to patterns that are more specific (i.e., containing less wildcards and more characters) and cover more URLs. To this end, for each pattern p, let coverage(p) be the number of URLs matching with p, wildcard(p) be the number of wildcards in p, and length(p) be the number of non-wildcard characters in p (not including the web domain). The score of a pattern is defined as

$$s ( p ) = ( \frac{1}{wildcard ( p ) + 1} + ρ \cdot length ( p ) ) \cdot {log}_{2} coverage ( p ) . \qquad ( 1 )$$

where ρ is set to 0.03 in one implementation.

In one implementation, the subset of good patterns is selected using a greedy algorithm, by selecting the pattern with a highest score, removing the URLs matched with it, and selecting the next pattern. This procedure is stopped when less than some percentage (e.g., five percent) of all URLs remain. Note that each selected URL pattern usually matches with a large number of URLs of the same format. Therefore, in the system 100, URLs matching with each pattern are treated as a separate source of information.

With respect to additional details of the information extractor 108, as generally described above the information extractor 108 takes the search trails of queries containing name entities, builds wrappers for the clicked links which are likely to be items of interest for the user, and extracts structured information from web pages of the same format. As also described above, the follow-up clicks on a page found from a result URL are usually relevant to the original search intent and are treated as relevant.

For each URL pattern p found in the result URLs, let U(p) be the set of the URLs matched with p. For each u in U(p), fc(u) is obtained, comprising the set of URLs clicked by follow-up clicks made on u, from the search trails of users. A general goal is to build wrappers that can extract URLs in fc(u) and their anchors from the result URLs, and also extract other URLs and anchors of the same format from all URLs in U(p).

Note that information extraction from web pages of uniform format has a variety of known approaches including regular expressions, HTML templates, partial tree alignment, and one based on “tag-path”—i.e., the tags on a path from the root to each node in the HTML DOM tree. In general, tag-paths are effective in identifying a type of clicked links in a set of uniformly formatted web pages, because the layout of such links is usually unique on the pages. There is often class information on tags that distinguish different types of HTML elements, and the class information specified for any tag that is closest to the leaf nodes is considered. For example, on pages with URL pattern http://www.music.site/music/*, each song URL may have a tag-path such as “<html><body><div><div><div><div><div><div><div><table><tbody><tr><td class=“subjectCell”><div><a>”.

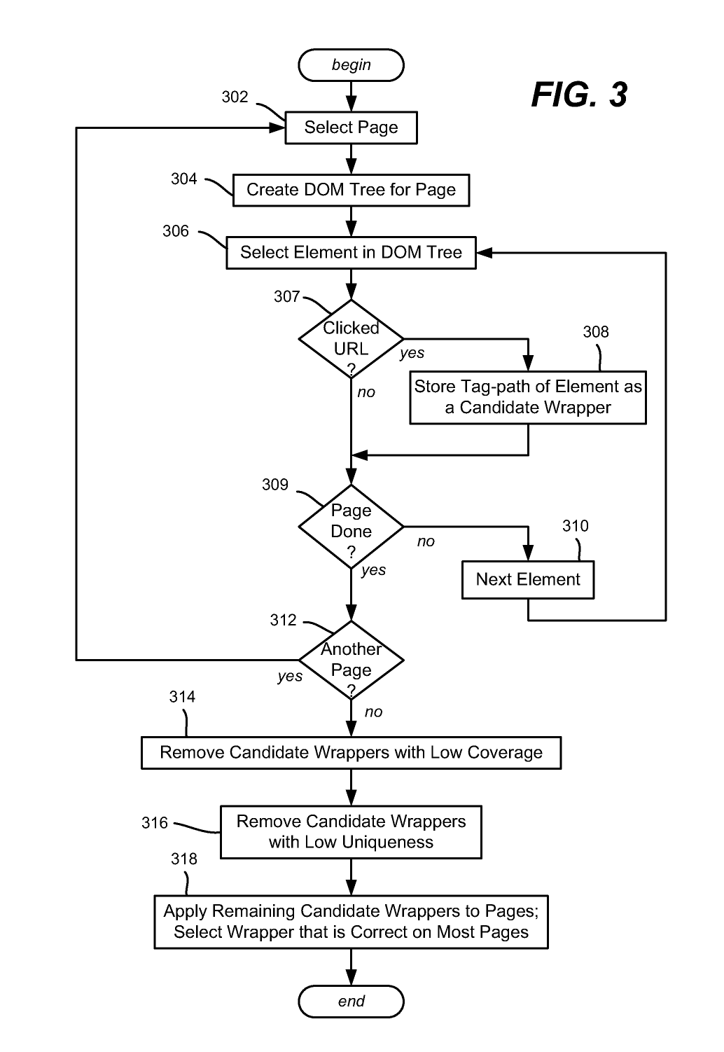

In one implementation, a process of the information extractor 108 uses tag-path based approach for building wrappers, as generally represented in FIG. 3. As represented by steps 302 and 304, when processing a URL pattern p, the process builds the HTML DOM tree for each page u in U(p) (looped by step 312) using a known tool. Via steps 306-310, the process searches for the clicked URLs on u in every element in the DOM tree. Whenever a clicked URL is found at step 307, the tag-path of that element is stored as a candidate wrapper at step 308. Step 312 repeats this part of the process for the other pages.

After generating the candidate wrappers, the process calculates the coverage of each of them, e.g., the percentage of URLs with follow-up clicks that can be extracted by this wrapper. Any candidate wrappers with coverage below a threshold (e.g., five percent) are removed (filtered) at step 314, and the remaining ones are used to extract data.

In many instances, there are wrappers that extract apparently useless data, which may be removed in another filtering process. For example, some wrappers extract items containing navigational links (e.g., “Photos”, “Videos”) or function links (e.g., “sort by year”). In one implementation, these wrappers are removed by calculating the uniqueness of the anchor texts and URLs extracted by a wrapper, e.g., the number of unique anchor texts (or URLs) divided by the total number. Any wrapper with uniqueness below a threshold (e.g., twenty percent) for anchor texts or URLs is removed (step 316).

After generating the candidate wrappers, a single wrapper is selected for extracting entity names, because each page contains a single entity name. In one implementation, a wrapper is considered correct on a page if when the entity name is compared versus the extracted data, the wrapper extracts exactly one string that is the entity name. The wrapper that is correct on the majority of the pages is selected, and is used to extract the entity name from each page, as generally represented by step 318.

In addition to extracting the clicked items from web pages following each URL pattern, the entity name is extracted from each page in order to know to which entity these items belong. This can be done using the same approach based on tag-paths, with some minor modifications, including that since the entity name often appears with some extra text in HTML elements, such text is incorporated into the wrappers. For example, consider building a candidate wrapper from the page of a hypothetical musician named Mizz Muzic on XYZ Music (http://music.XYZ.com/artist/mizzmuzic/987654321), in which “Mizz Muzic” appears in the page title which is “Mizz Muzic—XYZ Music. A candidate wrapper of “<html><head><title>(*)—XYZ Music” is built, in which (*) is a wildcard and represents the string to be extracted.

Notwithstanding the filtering at steps 314 and 316, although many irrelevant wrappers and items can be removed in this manner, others may remain, e.g., for musicians' songs, wrappers may extract musicians' names, albums, concerts, user comments, and so forth. As described herein the authority analyzer 118 operates to identify the relevant wrappers and combine data from them in another filtering process.

In one implementation, the authority analyzer 118 uses a graph-regularization based approach to identify the relevant items and good wrappers. In general, the authority analyzer 118 builds a graph containing the extracted data items, with each item being a node in the graph. An edge is added between each pair of data items that are extracted from parts of pages with the same format. The graph-regularization method assigns a score to each node, so that nodes connected by an edge have similar scores, whereby a score is assigned to each data item that indicates how likely that data item is to be correct.

In general, an item is more likely to have higher relevance if it is provided by wrappers that provide many relevant items. An item is also likely to have higher relevance if it is provided by many wrappers, each providing some relevant items. Further, an item is likely to be relevant to a topic if it is clicked by one or more follow-up clicks of a query on that topic. Note that while some follow-up clicks are on irrelevant items, this may be handled by optimizing a function that combines the items provided by the wrappers, whereby a relatively small number of irrelevant clicks will not affect the accuracy. If a wrapper provides irrelevant items, even if a few of them are clicked, the wrapper will still not be considered relevant because the items extracted by this wrapper are different from those extracted by most other wrappers, and therefore the follow-up clicks on the true relevant items will not enhance the relevance of this wrapper. The wrappers extracting relevant items will enhance the relevance of each other as they often extract similar set of items.

A general goal of the authority analyzer 118 is to assign a relevance score to each item so that items extracted by the same wrapper have similar scores, and items with more follow-up clicks have higher scores. Graph regularization operates to assign values to each node in a graph, so that neighbor nodes have similar values and the value of each node is similar to its pre-assigned value (which is usually a class label taking value of zero (0) or one (1)).

As described herein, a graph is built that contains a node for each item and an edge between each two nodes if the corresponding items are extracted by same wrapper. However, because an item not being clicked means its relevance is unknown, not that the item is necessarily irrelevant, a zero or one label does not apply very well.

Thus, different weights are assigned to different nodes in the optimization procedure, with items receiving more clicks (more popular for users) being weighted higher. In other words, relatively very low weights are assigned to un-clicked items, and the weight of each clicked item is proportional to the number of clicks. An analytical solution to this problem, which can be computed efficiently, is set forth below.

For a category of entities and an intent word (e.g., musicians' songs), consider that there are n wrappers w₁, . . . , wₙ, and m items t₁, . . . , tₘ. An item may be provided by multiple wrappers, because items are considered to be the same if they are for the same entity and share the same name. Each wrapper w provides a set of items T(w); an n×m matrix W is constructed so that Wᵢₖ equals 1 if tᵢεT(wₖ) and 0 otherwise. Consider a graph G containing a node for each item. There is an edge eᵢⱼεE(G) if any wrapper provides both tᵢ and tⱼ, and its weight w(eᵢⱼ) is the number of such wrappers. Note that WW^{T} is the adjacency matrix of G, i.e., w(eᵢⱼ)=(WW^{T})ᵢⱼ.

A general goal is to assign a relevance score fᵢ to each item tᵢ, so that if tᵢ has high relevance, its neighbors in graph G should also have high relevance, and also that if tᵢ receives a follow-up click or clicks from a query on the specific search topic, it should have high relevance. Let f be the vector (f₁, . . . , fₘ), and y be a vector so that yᵢ=1 if ti receives a follow-up click or clicks. A function for optimization is

$$Q ( f ) = \frac{1}{2} ( {\sum }_{{e}_{ij} ∈ E ( G )} w ( {e}_{ij} ) \cdot {( \frac{{f}_{i}}{\sqrt{{d}_{i}}} - \frac{{f}_{j}}{\sqrt{{d}_{j}}} )}^{2} + μ {‖ f - y ‖}^{2} ) \qquad ( 2 )$$

where μ>0, and dᵢ equals the sum of all elements in the i^{th} row of WW^{T} (i.e., the total weight of all edges from the node of tᵢ).
The first part of Q(f) represents the coherence within the graph, which is added to the second part, which represents the coherence with labeled examples; these are the items receiving follow-up clicks. Q(t) is minimized when

f*=(1−α)(I−αS)⁻¹y (3)

where α=1/(1+μ), S=D^{-1/2}WWTD^{-1/2} and D is a diagonal matrix with Dᵢᵢ=D.

The relevance of an item is unknown if there is no follow-up click on it, which means there are only labels on some positive examples, but not on the majority of them and not on the negative examples. Therefore, the problem is more similar to one-class classification, and Q(t) cannot be used as is

In general an unlabeled item is considered to be positive if it is tightly related to positive items in the graph, and considered to be negative if otherwise. This can be modeled by modifying the optimization function Q(f), keeping the original as Qᵢ(f) and defining:

Q₂(f)=Σᵢ₌₁^{m}λᵢ(fᵢ−yᵢ)² (4)

where λᵢ is the weight of item tᵢ. Let fc(tᵢ) be the number of follow-up clicks on tᵢ. The weight λᵢ is set equal to 1 if fc(tᵢ)=0, and λᵢ=γ·fc(tᵢ) if fc(tᵢ)>0, where γ is a parameter that is much higher than 1. In this way it becomes less important that items without follow-up clicks match with their “labels”. Note that assigning different weights to different items is very different from assigning different labels because fᵢ and yᵢ represent the probability of an item being relevant and thus range from zero to one, and assigning very different yᵢ to different clicked items makes it very difficult to minimize Q(f).

Let Λ be a diagonal matrix that Λᵢᵢ=λᵢ. The function to be minimized becomes:

$$Q ( f ) = \frac{1}{2} ( {Q}_{1} ( f ) + {μ ( f - y )}^{T} Λ ( f - y ) ) . \qquad ( 5 )$$

Q(f) is minimized by

f*=μΛ′⁻¹(I−SΛ′⁻¹)⁻¹Λy (6)

Because the high dimensionality of S and the high cost of matrix inversion, it is impractical to directly compute f* based on equation (6). However, by setting f₀=y and iteratively computing fₖ₊₁=aSfₖ+(1−α)y (where α=1/1+μ)), then lim_{k→∞}(fₖ)=f* as defined in Equation (3). Equation (6) may be converted into:

$${αΛ}^{′} {f}^{*} = ( 1 - α ) {( I - α ( \frac{1}{α} S {Λ}^{′ - 1} ) )}^{- 1} Λ y \qquad ( 7 )$$

Because equation (7) is analogous to equation (3), a similar iterative procedure may be used:
1. Let x₀=Λy.
2. Repeat:
3.

$${x}_{k + 1} = α ( \frac{1}{α} S {Λ}^{′ - 1} ) {x}_{k} + ( 1 - α ) Λ y \qquad ( 8 )$$

4. Until d′ converges to d*
   By inferring lim_{k→∞}(xₖ)=αΛ′f*,

$${f}^{*} = \frac{1}{α} {Λ}^{′ - 1} {x}^{*} .$$

Note that S is an m×m matrix, and it is very costly to compute S when m is large. Step 3 may be decomposed into two steps to simplify computation. Let B=D^{-1/2}W. Step 3 may be decomposed into:

3(1). zₖ=B^{T}Λ′⁻¹xₖ (9)

3(2). xₖ₊₁=Bzₖ+(1−α)Λy (10)

It is easier to compute zₖ, which represents the score of each wrapper in the kth step. The number of non-zero entries in B is equal to that in W (since W is a diagonal matrix), which is the total number of items provided by the wrappers. Therefore, each iteration can finish in linear time with respect to input size. As is known, the above procedure converges when the maximum eigen value of 1/αSΛ′⁻¹ is not greater than one, which puts weight requirements on λ1.

In general, the relevance of each item can be computed using the above iterative procedure. After it converges, the final relevance of each item is known, from which the relevance of wrapper w₁ is inferred as the average relevance of its items:

$$rel ( {w}_{i} ) = \frac{{\sum }_{{t}_{i} ∈ T ( {w}_{i} )} {f}_{i}}{\vert T ( {w}_{i} ) \vert} \qquad ( 11 )$$

Because each URL pattern usually provides relevant items in a single format, the wrapper from each URL pattern with highest relevance is selected in one implementation, and other wrappers from the same URL pattern are ignored. Because the pages from each URL pattern with significant number of user clicks usually contain some relevant information, the “best” wrapper from each URL pattern is usually relevant. The process also removes wrappers with very low relevance scores (e.g., less than 0.001).

After selecting relevant wrappers and extracting data from different websites, the extracted data is combined. This is only needed if a unified list of extracted items for each entity is to be generated, which can be directly shown to users to answer their queries. When combining the items for an entity e, the list of items extracted by each wrapper for e is obtained. Then the items for each entity are ordered according to their popularities. An item appearing on multiple web domains for an entity is usually a popular item, therefore one way is to use the number of web domains providing each item to rank the items. Whenever there is a tie, the sum of the relevance of wrappers may be used as a tie-breaker, providing each item to resolve the ties. Note that the relevance of wrappers is not used to rank items, because relevance is different from popularity.

Because different web domains often represent the same item in slightly different ways, two item names are considered to be the same if their normalized forms are the same. An item name is normalized by removing contents in parentheses (e.g., year of a movie), applying stemming (e.g., Porter's stemmer) on each word, and sorting the words alphabetically. A list of items can be generated for each entity using the above procedure.

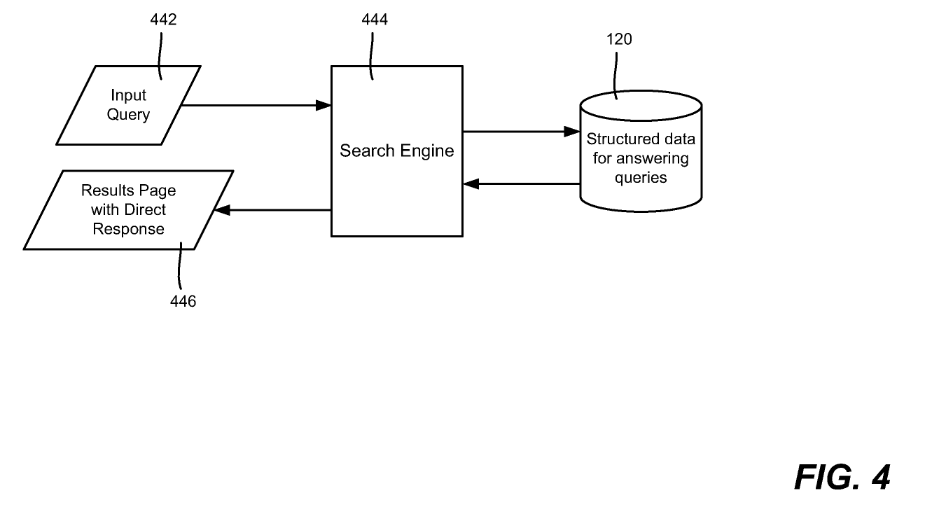

Once the structured data has been extracted, it may be used in an online information retrieval scenario. For example, as represented in FIG. 4, an input query 442 to a search engine 444 may result in the structured data being accessed. In this way, the search engine 444 may return a more directed response 446, e.g., a list of songs, the “snippets” revised to contain a list, a search results page that mixes conventional results with direct results, and so forth. The search results may be ranked based upon the predicted relevance of data items, as determined from one or more search and browsing logs.

Further, the semantics obtained from the structured data may be propagated among uniformly formatted web pages in a website. For example, if extracting the data indicates which part of a page http://www.music.site/music/mizzmuzic contains songs, songs can be extracted from such pages for other artists. This may be done online, or in advance to obtain additional structured data.

### Exemplary Operating Environment

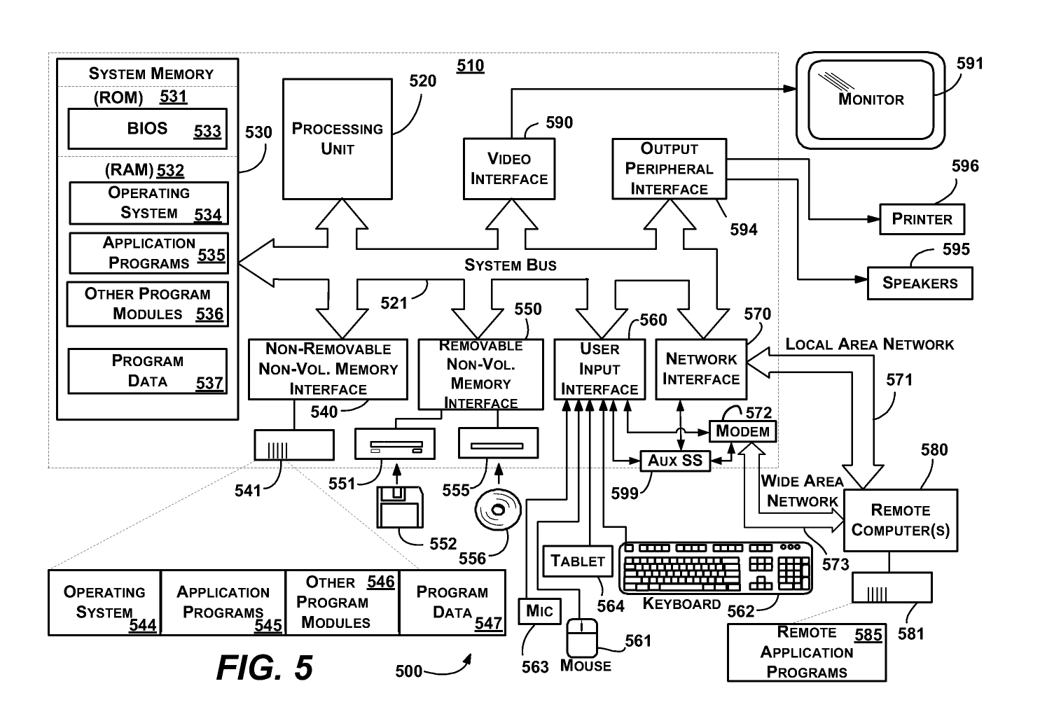

FIG. 5 illustrates an example of a suitable computing and networking environment 500 on which the examples of FIGS. 1-4 may be implemented. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during, start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are exemplary and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed on at least one processor comprising, extracting structured information from sets of URLs, including using search trail data to a determine a wrapper for extracting data items from web pages corresponding to each set, and determining relevant data items from the data items extracted from the web pages.

2. The method of claim 1 wherein using the search trail data to determine a wrapper comprises processing pages to generate a set of candidate wrappers, and to determine an entity name for each page.

3. The method of claim 2 further comprising, selecting a wrapper from among the candidate wrappers, including applying each candidate wrapper to the pages to obtain one or more strings extracted by that candidate wrapper, and selecting the wrapper based on the entity name inferred from the queries and clicks of web search users versus each string extracted by that candidate wrapper.

4. The method of claim 2 further comprising, removing candidate wrappers having low coverage from the set of candidate wrappers.

5. The method of claim 2 further comprising, removing candidate wrappers having low uniqueness from the set of candidate wrappers.

6. The method of claim 1 further comprising, summarizing patterns of URLs to provide the sets of URLs as uniformly formatted URLs, including inputting name entities of different categories, and processing a query log that indicates user clicks on URLs returned in a search page, to find common patterns.

7. The method of claim 6 wherein summarizing the patterns comprises comparing a pattern against patterns in a pattern set, generalizing a generalized pattern corresponding to an existing pattern in the pattern set, and adding the generalized pattern into the pattern set.

8. The method of claim 6 wherein summarizing the patterns comprises performing a comparison of a pattern against a pattern set, and adding the pattern into the pattern set based upon a result of the comparison.

9. The method of claim 1 wherein determining the relevant data items from the data items extracted from the web pages comprises using a graph regularization-based approach to identify the relevant data items, including representing each item as a node in the graph, and adding an edge between each pair of data items that are extracted from parts of pages having a common format.

10. The method of claim 9 further comprising, assigning scores to the nodes, each score indicating a likelihood of relevance for that node's associated data item.

11. The method of claim 9 further comprising, processing the graph to determine whether a wrapper provides relevant or irrelevant items.

12. The method of claim 1 further comprising, accessing the structured data to provide a more directed search result in response to a query.

13. The method of claim 12 further comprising ranking search results based upon predicted relevance of data items determined from one or more search and browsing logs.

14. The method of claim 1 further comprising propagating semantics among uniformly formatted web pages in a website.

15. In a computing environment, a system comprising, a URL pattern summarizer that determines patterns of URLs among URLs clicked for named entity queries and provides sets of uniformly formatted URLs based upon the patterns, and an information extractor that consumes the sets of uniformly formatted URLs and search trail data to determine one or more wrappers for each set, and extracts structured information from web pages in that set.

16. The system of claim 15 further comprising an authority analyzer that determines relevant data items from the structured information extracted from the web pages, by processing data extracted from similarly or uniformly formatted parts in web pages.

17. The system of claim 15 wherein the information extractor determines one or more wrappers for each set by processing the web pages to generate a set of candidate wrappers

18. One or more computer-readable media having computer-executable instructions, which when executed perform steps, comprising:
summarizing patterns of URLs to provide sets of uniformly formatted URLs, each set associated with a named entity; and
for each set:
(a) using search trail data to determine wrappers for extracting data items from the URL pages corresponding to that set; and
(b) selecting a wrapper for extracting structured data corresponding to the named entity associated with that set.

19. The one or more computer-readable media of claim 18 wherein selecting the wrapper includes determining relevance of data items in the structured data extracted by a wrapper.

20. The one or more computer-readable media of claim 18 wherein determining the relevance of the data items comprises representing each data item as a node in a regularization graph, adding an edge between each pair of data items that are extracted from parts of pages having a common format, and assigning scores to the nodes, each score indicating a likelihood of relevance for that node's associated data item.
